(19) United States
(12) Patent Application Publication
(10) Pub. No.: US 2010/0045476 A1
(43) Pub. Date: Feb. 25, 2010

(54) ULTRASONIC ACOUSTIC WARNING DEVICE

(76) Inventor: Martin L. Lenhardt, Hayes, VA (US)

Correspondence Address: Hershkovitz & Associates, LLC, 2845 Duke Street, Alexandria, VA, 22314, US

(21) Appl. No.: 12/522,160

(22) PCT Filed: Jan. 4, 2008
(86) PCT No.: PCT/US08/50238

§ 371 Date: Jul. 3, 2009

Related U.S. Application Data
(60) Provisional application No. 60/878,339, filed on Jan. 4, 2007.

(51) Int. Cl. G08B 25/08

(52) U.S. Cl. 340/692

(57) ABSTRACT

A method and apparatus for discretely alerting an operator or operators of a state of alarm or for conveying sensory or other signal data to operator or operators is described. Such method and device functions to transmit signals in the ultrasonic band to an operator and utilizes a transducer to covertly transfer the signal to said operator.

### CROSS-REFERENCE TO RELATED APPLICATIONS

This application claims the benefit of provisional patent No. 60/878,339 application entitled “ULTRASONIC ACOUSTIC WARNING DEVICE” filed Jan. 4, 2007, the entirety of which is incorporated by reference.

### FIELD OF INVENTION

This invention relates generally to a warning device and method of using such device, and more particularly, to an ultrasonic warning device and method for covertly alerting select individuals.

### BACKGROUND OF THE INVENTION

Devices that use acoustic sound waves to alert individuals of an emergency or other important state are a ubiquitous facet of modern life. Although such devices have long been known, acoustically based alarms suffer several drawbacks that prevent them from most safely and efficiently alerting individuals to a critical state or condition. First, such alarms are by necessity intensely loud. While this assures that the alarm is heard by persons distant from the alarm or by persons whose hearing is poor or obstructed by background noise, it can needlessly startle individuals and hamper effective coordination of efforts among individuals who must work as a group in response to an alarm. Second, since such alarms are not directed to specific individuals, alarms are frequently ignored or turned off. Thirdly, alarms alert persons to whom the alert is not relevant and can thereby cause confusion. While some devices, such as the “Firearm Alarm Having Remote Indicator” in U.S. Pat. No. 5,715,623 to Mackey, produce non-audible alarm signals, such signals are converted to audible signals upon transmittal to a discrete receiving unit. All persons within hearing range of the receiving unit can hear such audible alarms. Therefore, the current art does not describe a means and method for producing a warning or other signal that can be relayed covertly to individuals. As such, there is a need for a device that can discretely, covertly, and robustly alert only specified individuals such as an operator for an alarmed piece of machinery or other device.

U.S. Pat. Nos. 6,731,769, 5,047,994 and 4,982,434 to Lenhardt describe means for providing ultrasonic signals via transducers (and related algorithms for modifying ultrasonic signals). These references are hereby expressly incorporated by reference.

### SUMMARY AND OBJECTS OF THE INVENTION

The present invention is an ultrasonic acoustic warning device that comprises an alert coupled to (1) an ultrasonic modulator coupler. An alert is a signal indicating a state of alarm but may also comprise, in addition to the alert or by itself, direct sensory data in either a modulated or unmodulated form and may further comprise standard audio signals such as speech. The ultrasonic modulator coupler is further coupled to (2) an amplifier and the amplifier is coupled to (3) an emitter. An alert produces a signal and the ultrasonic modulator coupler then modulates this signal to an ultrasonic frequency. Such modulation is usually limited to upshifting the frequency of the signal such that the pitch of the signal is increased; however, further processing of the signal to increase comprehensibility and audibility are contemplated and are described in the incorporated references. This modulated signal is then amplified and emitted whereupon the signal can be received by (4) an ultrasonic receiver. A (5) transducer receives the signal and can produce a vibration or acoustic signal modulated to correspond to the signal but generally at a higher pitch, i.e. in the ultrasonic frequency range of about between 20 to 40 kilo Hertz but can be extended to 100 kilo Hertz. If the signal is already modulated at an ultrasonic pitch then the ultrasonic modulator coupler can be bypassed. The signal source may even be the direct signal stream of a sensor or an auditory message. Such transducer will generally be adapted to emit ultrasonic acoustic waves audible to a person on whom the transducer is affixed. The device can be affixed, for example, on the mastoid region of the head, where it can interact with the auditory functions of the ear. For long distance signals, the signal stream can be modulated to a radio-frequency (“RF”) band and emitted. The emitted signal may be received and remodulated to an ultrasonic frequency band as above.

As such, it is an object of this invention to provide an alarm device that operates acoustically but does not contribute to the creation of background noise and is not masked by a high level of ambient noise.

It is another object of this invention to provide an alarm device that can covertly signal a select person or persons that a state of alarm has occurred or to covertly convey sensory or other data including speech.

It is yet another object of this invention to provide for such an alarm to communicate to an individual using ultrasonic acoustic waves.

It is also an object of this invention to provide an adaptation of the ultrasonic acoustic warning device that allows for the use of a hand held ultrasonic sensor, also known as an “acoustic flashlight”. Such an acoustic flashlight would be capable of being directed by an operator to scan a region containing emitters transmitting signals at an ultrasonic pitch.

At least one of the above objects is met in whole or in part by the present invention. Additional objects are apparent by the following description and claims.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a block diagram illustrating the pathway of various alert signals towards final transduction into a vibratory or ultrasonic auditory signal;

FIG. 2 is a diagrammatic representation of one embodiment of the invention in which sensory data is received by an ultrasonic transducer; and

FIG. 3 is a diagrammatic representation of one embodiment of the invention incorporating an ultrasonic flashlight.

### DETAILED DESCRIPTION OF THE INVENTION

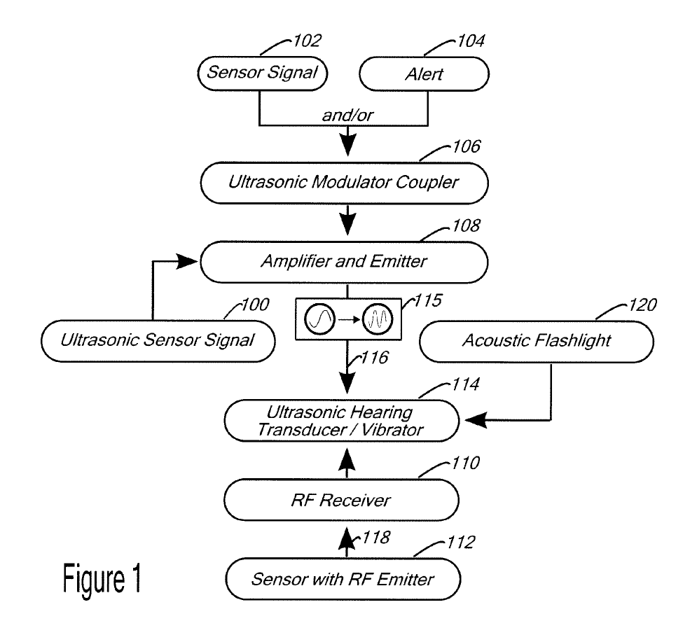

The embodiments of the invention are directed to a method and an apparatus for utilizing ultrasonic acoustic sound waves to discretely signal or warn a select individual or individuals. Such a device according the invention relays a signal from a device adapted to transmit such a signal to an ultrasonic modulator coupler. In FIG. 1, such a signal can comprise a signal stream from an alert on an alarmed piece of machinery (104).

Alternatively, such a signal could originate from a sensor (102). These signals are modulated to the ultrasonic region by the ultrasonic modulator coupler (106) whereupon the modulated signal is transmitted to an amplifier and emitter array (108). The array (108) functions to transmit a sufficiently strong signal in the ultrasonic region to a distant receiver. The array (108) can also directly receive a signal already modulated in the ultrasonic region by, for example, a signal source (100) that is already modulated at this range. Upon transmittal (116) such a signal is received by an ultrasonic hearing transducer or vibrator (114). The signal may be processed to provide a transform of the signal by a signal processor (115). The signal processor may utilize gate or drain pulsing or other modulation transformation techniques to produce the transform. The transducer/vibrator (114) convey the received signal to an operator.

For applications involving long distance transmittal of a signal, the transducer/vibrator (114) may be adapted to receive via an RF receiver (110) a signal (118) in the RF spectrum transmitted by a sensor or alarm (112) adapted with an RF emitter. Finally, the transducer may be adapted to receive a signal from an acoustic flashlight (120). Such flashlight (120) is adapted to sense ultrasonic signals emitted from distant transmittal sites and can thereby be used by an operator to scan an alarm, sensor, alert, or array thereof that transmits a signal. When the flashlight receives such signal it is transmitted to the operator via the transducer or vibrator (114).

It is to be noted that the signal can be any tone or tonal signal including without limit: single tones, gated tones, series of tone pips, modulated tones, noise of filter noise bursts, and speech. The tone may be processed as by gate or drain pulsing.

Further, the signal may be supplemented by other alert methods comprising alternative sensory stimulation means. Such means include vibration devices or thermal devices capable of producing heat pulses. For example, the ultrasonic acoustic device may also comprise a vibrator that alerts to a specific state or condition; alternatively, the device may have a thermal pad that is adapted to rapidly heat in response to a specific state or condition.

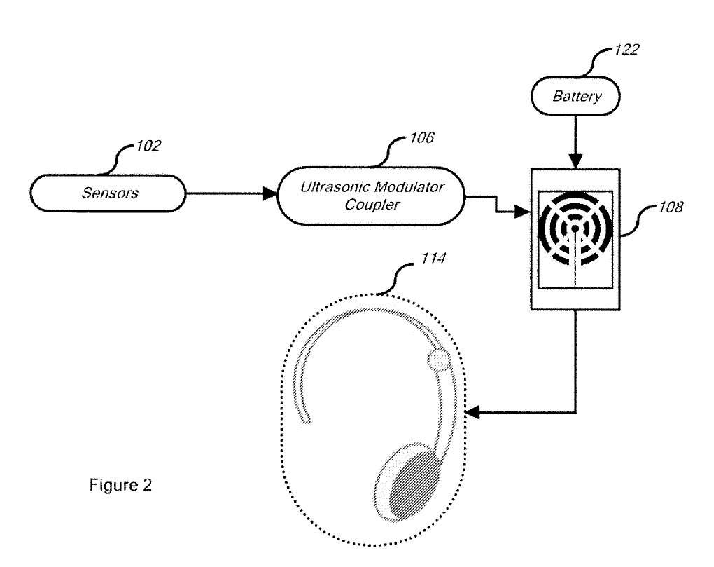

In another embodiment of the present invention, illustrated in FIG. 2, sensors (102) can comprise distance sensors on the superstructure of ships or planes, intrusion sensors on planes or secured areas, any acoustic warning device, and even medical warning devices. Such sensors feed into the ultrasonic modulator coupler (106) which is directed to amplifier and emitter (108). The amplifier and emitter (108) may be powered by a battery (122). The signal may then travel to the ultrasonic hearing transducer (114).

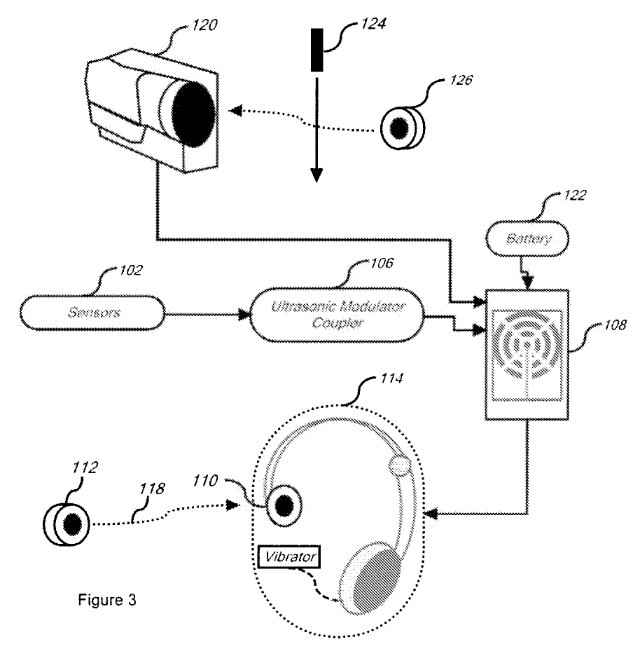

In yet another embodiment of the present invention, illustrated in FIG. 3, the system and device can be adapted for both long distance and short distance signaling. For example, a sensor with an RF emitter (112) can emit an RF signal (118) to an RF receiver (110) on the transducer (114). A vibrator or any other sensory stimulus device may supplement the transducer. In a short-range embodiment, a hand-held acoustic flashlight (120) can detect (124) a signal emanating from a device (126). The signal can then be forwarded to the transducer (114) by means already discussed. The acoustic flashlight thereby allows an operator to scan for an emitted signal.

The above warning device has numerous commercial and non-commercial uses. For example, a restaurant or fast-food chain could equip its staff with transducers. Then, when an alert, say an alarm that indicates food has been cooked, is activated, individuals who have responsibility for that station can quickly, efficiently, and covertly be apprised of this state. In another application, a waitperson could have a transducer linked to call buttons on tables the waitperson is currently serving. Then, when a customer is in need of service, the waitperson can quickly and quietly be alerted. Such an application could be extended to flight-cabin use, wherein a flight attendant can be called without creating noise for other passengers. In yet another application, an operator could use the acoustic flashlight to scan a series of sensors on groups of machines.

In another context, because alarms in intensive care units in hospitals suffer from overlapping acoustic spectra and are often confused or not localized properly, thereby delaying care, in one embodiment of the present invention, specific targeting of patients can be achieved without causing patient distress by the covert signaling of a specific care-giver. The signal could be in response to an alarm, a request for attention by the patient, or any other status-change or condition. The foregoing alarms can also trigger ultrasonic or high sonic messages (10-100 kHz) detailing the specific patient and need.

Another application is prison operations where secrecy is paramount to safety; others are military and fire/rescue/search operations. Finally, such a device could also be used for true covert operations such as SWAT or other stealth operations.

The above applications are merely demonstrative and do not limit the broad scope of this invention.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention. It is further known that other modifications may be made to the present invention, without departing the scope of the invention, as noted in the appended claims.

I claim:

1. An ultrasonic acoustic warning device, comprising:
an alert coupled to an ultrasonic modulator coupler, said ultrasonic modulator coupler further coupled to an amplifier, said amplifier coupled to an emitter, and wherein said alert produces a signal and said signal is modulated by said ultrasonic modulator coupler to an ultrasonic frequency, and wherein the modulated signal is amplified by said amplifier, and wherein the modulated and amplified signal is emitted and said emitted signal is received by an ultrasonic receiver and the received signal is sent to an ultrasonic transducer.

2. The ultrasonic acoustic warning device of claim 1 in which said transducer is adapted to vibrate in accordance with the modulated signal provided thereto.

3. The ultrasonic acoustic warning device of claim 1 in which said alert is the signal stream of at least one sensor.

4. The ultrasonic acoustic warning device of claim 1 in which said transducer is adapted to emit ultrasonic acoustic waves audible to a person on whom said transducer is affixed.

5. The ultrasonic warning device of claim 4 wherein said waves comprise a tone or tonal signal comprising singly or in combination: single tones, gated tones, series of tone pips, modulated tones, noise or filter noise bursts, and speech.

6. The device of claim 4 in which said transducer is affixed on the mastoid area of the head or other parts of the body.

7. The ultrasonic acoustic warning device of claim 1 in which an ultrasonic signal is fed directly into said amplifier and said emitter.

8. The ultrasonic acoustic warning device of claim 1 in which a radio-frequency modulated signal is received by a radio-frequency receiver and the captured signal is fed to said ultrasonic transducer.

9. The ultrasonic acoustic warning device of claim 1 in which a signal processor is utilized to provide a transform of said signal.

10. The ultrasonic acoustic warning device of claim 9 in which said transform is achieved by gate or drain pulsing.

11. The ultrasonic acoustic warning device of claim 1 in which said device is supplemented by an additional sensory stimulation devices.

12. The ultrasonic acoustic warning device of claim 11 in which said additional sensory stimulation device is adapted to produce vibrations.

13. The ultrasonic acoustic warning device of claim 11 in which said additional sensory stimulation device is adapted to produce a thermal signal.

14. A method of discretely alerting an operator to a signal or alarm, comprising the steps of:
(a) receiving a first signal from a device;
(b) modulating said first signal to the ultrasonic frequency range if said signal is not already so modulated, thereby producing or having a second signal;
(c) amplifying said second signal;
(d) emitting said second signal;
(e) receiving said second signal by a receiver; and
(f) utilizing a transducer to transmit the received second signal to said operator.

15. The method of claim 14 in which said first signal is received by an acoustic flashlight.

16. The method of claim 15 in which said operator utilizes said acoustic flashlight to scan for emitted signals.

17. The method of claim 14 in which said first signal is an alarm signal.

18. The method of claim 14 in which said first signal is ultrasonic sensory data.

19. The method of claim 14 in which said first signal is sensory data.

20. The method of claim 14 in which said first signal comprises speech.

21. The method of claim 14 in which said second signal is of about between 20 to about 100 kilo Hertz.

22. The method of claim 21 in which said second signal is of about 20 to 40 kilo Hertz.

23. The method of claim 14 in which said second signal is also processed by a signal processor to produce a transform.

24. The method of claim 23 in which said transform is produced by gate or drain pulsing.

25. The method of claim 14 in which the signal can be a tone or tonal signal comprising singly or in combination: single tones, gated tones, series of tone pips, modulated tones, noise or filter noise bursts, and speech.
